(19) United States
(12) Patent Application Publication
(10) Pub. No.: US 2019/0129210 A1
(43) Pub. Date: May 2, 2019

(54) LIQUID CRYSTAL PANEL AND MANUFACTURE METHOD THEREOF, LIQUID CRYSTAL DISPLAY DEVICE

(71) Applicant: Wuhan China Star Optoelectronics Technology Co., Ltd, Wuhan, Hubei (CN)

(72) Inventors: Wanting YIN, Wuhan, Hubei (CN); Hung-ming SHEN, Wuhan, Hubei (CN); Bingkun YIN, Wuhan, Hubei (CN); Cong TAN, Wuhan, Hubei (CN)

(21) Appl. No.: 15/579,134

(22) PCT Filed: Nov. 22, 2017
(86) PCT No.: PCT/CN2017/112250

§ 371 Date: Aug. 24, 2018

(30) Foreign Application Priority Data
Oct. 31, 2017 (CN) 201711047720.3

(51) Int. Cl. G02F 1/1339; G02F 1/1335

(52) U.S. Cl. CPC G02F 1/1339; G02F 1/133512; G02F 2001/13398; G02F 2202/28; G02F 1/133516

(57) ABSTRACT

A liquid crystal panel and a liquid crystal display device are provided. The liquid crystal panel comprising array substrate and color filter substrate are corresponding to each other. The color filter substrate includes substrate and black matrix positioned on substrate. The liquid crystal panel comprises interval holding portion, an end of interval holding portion is contacted to black matrix, and another end of interval holding portion is contacted to array substrate for keeping distance between array substrate and color filter substrate. The interval holding portion is made by organic material has low elasticity modulus and high extension rate. It can ensures optical path difference without changed while the liquid crystal panel be curved. Therefore, enhances quality of display image. In addition, the method of manufacture liquid crystal panel is simplified in this invention such that could saves cost.

### RELATED APPLICATIONS

The present application is a National Phase of International Application Number PCT/CN2017/112250, filed Nov. 22, 2017, and claims the priority of China Application No. 201711047720.3, filed Oct. 31, 2017.

### FIELD OF THE DISCLOSURE

The disclosure relates to a display technical field, and more particularly to a liquid crystal panel and manufacture method thereof, liquid crystal display device.

### BACKGROUND

A liquid crystal display (LCD) is a thin flat display apparatus which comprises a certain amount of color or monochrome pixels and is disposed before a light source or a reflecting surface. Because the liquid crystal display has low power consumption and is characterized in high display quality, small size and light weight, it is favored by peoples and becomes a main display apparatus. Nowadays, the common used of the liquid crystal display at least includes TFT array substrate and color filter substrate correspondingly positioned to the TFT array substrate, and a liquid crystal layer positioned between the TFT array substrate and the color filter substrate.

Flexible display panel become a development trend due to numbers of advantageous such as super-thin, light weight, durable, freedom to design, could rolling. When manufacture the flexible crystal panel, the panel will provides changing of gap (which is between color filter substrate and TFT array substrate) during curving. Therefore, the gap will be changed by stress effect when curving deformation of the flexible liquid crystal panel, the central of gap will become narrow and two lateral of gap will become wider. The change of gap will causes change of optical path difference so that the quality of display image getting worse.

### SUMMARY

A technical problem to be solved by the disclosure is to provide a liquid crystal panel and manufacture method thereof, liquid crystal display device, which the optical path difference without changed while be curved.

Furthermore, the disclosure further provides a display device including a liquid crystal panel. The liquid crystal panel comprising an array substrate and a color filter substrate is corresponding to the array substrate, the color filter substrate includes a substrate and a black matrix positioned on the substrate. The liquid crystal panel further comprises an interval holding portion, an end of the interval holding portion is contacted to the black matrix, and another end of the interval holding portion is contacted to the array substrate for keeping distance between the array substrate and the color filter substrate. The interval holding portion is made by an organic material has low elasticity modulus and high extension rate.

In an embodiment, the black matrix has a through hole, and the through hole exposing the substrate positioned under the black matrix, one end of the interval holding portion is extending to the through hole for contacting the exposed substrate.

In an embodiment, the color filter substrate further includes a color photoresist layer, the color photoresist layer comprises a red photoresist layer, a green photoresist layer and a blue photoresist layer, the black matrix defining openings by array distribution, each of the red photoresist layer, the green photoresist layer and the blue photoresist layer is positioned to the correspondingly opening.

According to another aspect of the disclosure, the disclosure further provides a liquid crystal display device. The liquid crystal display device includes a liquid crystal panel and a backlight module. The liquid crystal panel and the backlight module is corresponding to each other, the backlight module provides light source to the liquid crystal panel for displaying the image on the liquid crystal panel. The liquid crystal display device as described above.

According to another aspect of the disclosure, the disclosure yet further provides a method of manufacture the liquid crystal panel, comprising following steps. Providing a color filter substrate, the method of manufacture the color filter substrate comprising steps. Forming a black matrix on a substrate. Forming an interval holding portion, an end of the interval holding portion is contacted to the black matrix, and the interval holding portion is made by an organic material has low elasticity modulus and high extension rate. Providing an array substrate. Assembling the array substrate corresponding to the color filter substrate such that another end of the interval holding portion is contacted to the array substrate for keeping distance between the array substrate and the color filter substrate.

In an embodiment, the method of manufacture the color filter substrate further comprising following steps. Forming a through hole in the black matrix after forming black matrix on the substrate and before forming the interval holding portion, and the through hole exposing the substrate positioned under the black matrix. When forming the interval holding portion, one end of the interval holding portion is extending to the through hole for contacting the exposed substrate.

In an embodiment, the method of manufacture the color filter substrate further comprising following steps. When forming the black matrix on the substrate, the black matrix defining openings by array distribution. Forming a red photoresist layer, a green photoresist layer or a blue photoresist layer in the correspondingly opening.

In an embodiment, the organic material is made of at least one of epoxy, acrylate resin and polytetrafluoroethylene.

The advantage of this invention is that the interval holding portion of this invention which is made by an organic material has low elasticity modulus and high extension rate, it can ensures optical path difference without changed while the liquid crystal panel be curved. Therefore, enhances quality of display image. In addition, the method of manufacture liquid crystal panel is simplified in this invention such that could saves cost.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a structural schematic view of a liquid crystal panel according to an embodiment of the disclosure;

FIG. 2 is a structural schematic view of a liquid crystal display device according to an embodiment of the disclosure; and

FIG. 3A to 3E are manufacture flow chart of the liquid crystal panel according to an embodiment of the disclosure.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

Here, it is also worthy to note that, in order to prevent the present disclosure from being obscured due to unnecessary details, the drawings only illustrate the structure and/or processing steps closely related to the technical solution of the present disclosure, while other details less related to the present disclosure are omitted.

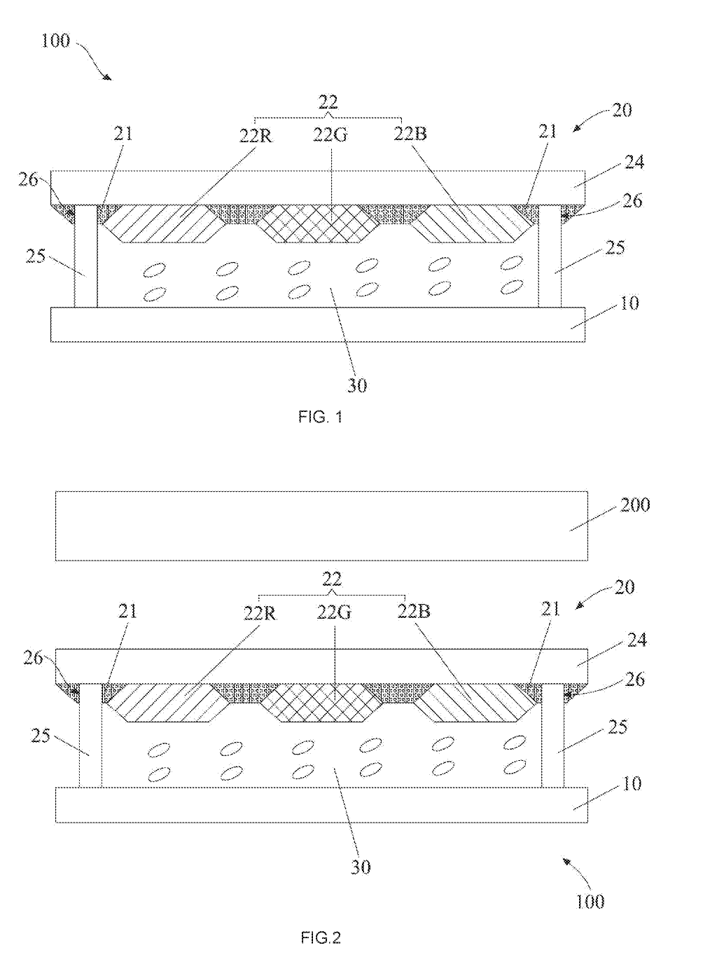

The liquid crystal panel is provides according to this embodiment, please refer to FIG. 1. FIG. 1 is a structural schematic view of a liquid crystal panel according to an embodiment of the disclosure.

Please refer to FIG. 1, the liquid crystal panel 100 according to an embodiment of the disclosure, comprising an array substrate (which is thin-film transistor array substrate) 10 and a color filter substrate 20 is corresponding to the array substrate 10. A liquid crystal layer 30 is positioned between the array substrate 10 and the color filter substrate 20. Wherein the array substrate 10 includes some circuit structure for driving pixel display, which is a thin-film transistor, a data line, a scan line and a pixel electrode and so on.

The color filter substrate 20 includes a substrate 24, a black matrix 21, a color photoresist layer 22 and an interval holding portion 25.

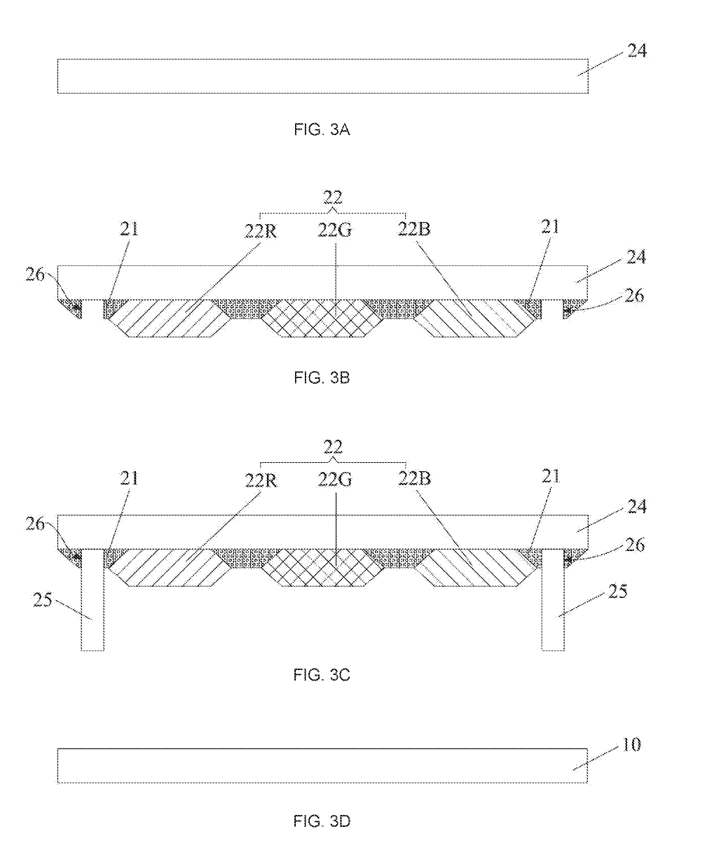

The black matrix 21, the color photoresist layer 22 and the interval holding portion 25 are positioned on the substrate 24. Specifically, the black matrix 21 is positioned on the substrate 24 for defined a plurality of openings according to array distribution. The color photoresist layer 22 comprises a red photoresist layer 22R, a green photoresist layer 22G and a blue photoresist layer 22B, each of the red photoresist layer, the green photoresist layer and the blue photoresist layer are respectively positioned to the correspondingly opening. It is noted that, FIG. 2 only illustrates a red photoresist layer 22R, a green photoresist layer 22G and a blue photoresist layer 22B. In liquid crystal panel, usually a red photoresist layer 22R is corresponding to a red sub-pixel, a green photoresist layer 22G is corresponding to a green sub-pixel, a blue photoresist layer 22B is corresponding to a blue sub-pixel, and each pixel unit comprises a red sub-pixel, a green sub-pixel and a blue sub-pixel. FIG. 2 only illustrates three openings.

Please refer to FIG. 1 again. An end of the interval holding portion 25 is contacted to the black matrix 21, and another end of the interval holding portion 25 is contacted to the array substrate 10, which for keeping the distance between the array substrate 10 and the color filter substrate 20. The interval holding portion is made by an organic material has low elasticity modulus and high extension rate. The organic material could be black adherence material for example epoxy, acrylate resin and polytetrafluoroethylene. In this embodiment, the interval holding portion 25 is made by the organic material has low elasticity modulus and high extension rate. Therefore, when the liquid crystal panel is curving, the interval holding portion 25 made by an organic material has low elasticity modulus and high extension rate, which could ensures the optical path difference of the liquid crystal layer 30 without changed. It enhances quality of display image.

Further, in this embodiment, please refer to FIG. 1. The black matrix 21 has a through hole 26. The through hole 26 exposing the substrate 24 positioned under the black matrix 21. One end of the interval holding portion 25 is extending to the through hole 26 for contacting the exposing substrate 24. The adhesive force between the interval holding portion 25 and the substrate 24 is stronger than the adhesive force between the interval holding portion 25 and the black matrix 21. It could avoid peeling between the interval holding portion 25 and the black matrix 21, so that enhances reliability of interval holding portion 25.

The liquid crystal display device is provided in this embodiment, please refer to FIG. 2. FIG. 2 is a structural schematic view of a liquid crystal display device according to an embodiment of the disclosure. Please refer to FIG. 2, the liquid crystal display device of the embodiment in this disclosure, comprising a liquid crystal panel 100 and a backlight module 200. The liquid crystal panel 100 is correspondingly positioned to the backlight module 200. The backlight module 200 provides light source to the liquid crystal panel 100 for displaying the image on the liquid crystal panel 100.

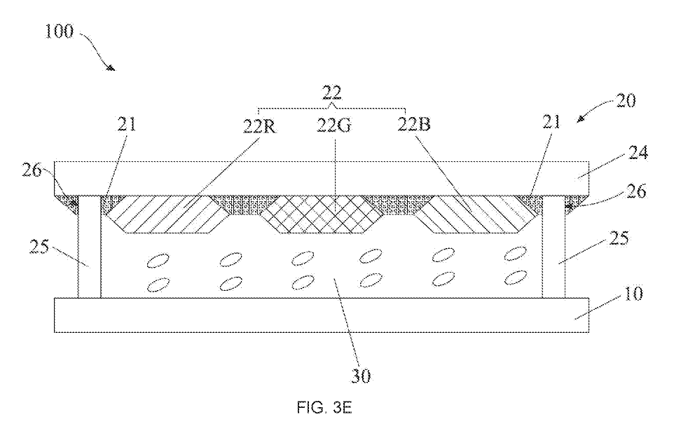

In addition, the method of manufacture the liquid crystal panel is provided in this embodiment; please refer to FIG. 3A to 3E. FIG. 3A to 3E are manufacture flow chart of the liquid crystal panel according to an embodiment of the disclosure. The method of manufacture the liquid crystal panel of the embodiment in this disclosure, comprising following step;

Step 1; please refer to FIG. 3A, providing a substrate 24. The substrate 24 could be for example a transparent glass substrate or a transparent resin substrate. It is not limited thereto.

Step 2; please refer to FIG. 3B, forming a black matrix 21 on the substrate 24.

Step 3; please refer to FIG. 3C, forming an interval holding portion 25. An end of the interval holding portion 25 is contacted to the black matrix 21, and the interval holding portion 25 is made by the organic material has low elasticity modulus and high extension rate.

Step 1 to Step 3 described above are finishing manufacture of the color filter substrate 20.

Step 4; please refer to FIG. 3D, providing an array substrate 10. The array substrate 10 includes some circuit structure for driving pixel display which is a thin-film transistor, a data line, a scan line and a pixel electrode and so on.

Step 5; please refer to FIG. 3E, assembling the array substrate 10 corresponding to the substrate 24 such that another end of the interval holding portion 25 is contacted to the array substrate 10 for keeping distance between the array substrate 10 and the substrate 24.

Further, in the Step 2. The black matrix 21 defining openings according array distribution when forming the black matrix 21, and forming a red photoresist layer 22R, a green photoresist layer 22G or a blue photoresist layer 22B in the correspondingly openings.

In addition, between the Step 2 and the Step 3. In this embodiment, forming a through hole 26 in the black matrix 21, and the through hole 26 exposing the substrate 24 positioned under the black matrix 21. Further, in Step 3, when forming the interval holding portion 25, one end of the interval holding portion 25 is extending to the through hole 26 for contacting the exposed substrate 24.

In sum, according to the embodiment in this present invention. The interval holding portion which is made by an organic material has low elasticity modulus and high extension rate; it can ensures optical path difference without changed while the liquid crystal panel be curved. Therefore, enhances quality of display image. In addition, the method of manufacture liquid crystal panel is simplified in this invention such that could saves cost.

It should be explained that the relationship terms, such as first and second, etc., in the present application are only used for distinguishing one entity or operation from another entity or operation without requiring or implying any actual relation or sequence existing between these entities or operations. Moreover, the term “include”, “contain” or any other variant means covering instead of exclusively including, so that the process, method, object or device including a series of factors not only includes those factors, but also includes other factors that are not explicitly listed, or further include inherent factors for this process, method, object or device. In a case of no more limitations being provided, the factors defined by the expression “include one . . . ” do not exclude additional identical factors existing in the process, method, object or device which includes the factors.

The above statements are only the specific embodiments of the present application. It should be pointed out that improvements and modification can be made by those ordinary skilled in the art without breaking away from the principle of the present application, also those improvements and modification should be considered as the protection scope of the present application.

What is claimed is:

1. A liquid crystal panel, comprising an array substrate and a color filter substrate is corresponding to the array substrate, the color filter substrate includes a substrate and a black matrix positioned on the substrate;
wherein the liquid crystal panel further comprises an interval holding portion, an end of the interval holding portion is contacted to the black matrix, and another end of the interval holding portion is contacted to the array substrate for keeping distance between the array substrate and the color filter substrate;
wherein the interval holding portion is made by an organic material has low elasticity modulus and high extension rate.

2. The liquid crystal panel according to claim 1, wherein the black matrix has a through hole, and the through hole exposing the substrate positioned under the black matrix, one end of the interval holding portion is extending to the through hole for contacting the exposed substrate.

3. The liquid crystal panel according to claim 1, wherein the color filter substrate further includes a color photoresist layer, the color photoresist layer comprises a red photoresist layer, a green photoresist layer and a blue photoresist layer, the black matrix defining openings by array distribution, each of the red photoresist layer, the green photoresist layer and the blue photoresist layer is positioned to the correspondingly opening.

4. The liquid crystal panel according to claim 2, wherein the color filter substrate further includes a color photoresist layer, the color photoresist layer comprises a red photoresist layer, a green photoresist layer and a blue photoresist layer, the black matrix defining openings by array distribution, each of the red photoresist layer, a green photoresist layer and a blue photoresist layer is positioned to the correspondingly opening.

5. The liquid crystal panel according to claim 1, wherein the organic material is made of at least one of epoxy, acrylate resin and polytetrafluoroethylene.

6. A liquid crystal display device, comprising a liquid crystal panel and a backlight module, the liquid crystal panel and the backlight module is corresponding to each other, the backlight module provides light source to the liquid crystal panel for displaying the image on the liquid crystal panel, the liquid crystal panel comprises an array substrate and a color filter substrate is corresponding to the array substrate, the color filter substrate includes a substrate and a black matrix positioned on the substrate;
wherein the liquid crystal panel further comprises an interval holding portion, an end of the interval holding portion is contacted to the black matrix, and another end of the interval holding portion is contacted to the array substrate for keeping distance between the array substrate and the color filter substrate;
wherein the interval holding portion is made by an organic material has low elasticity modulus and high extension rate.

7. The liquid crystal panel according to claim 6, wherein the black matrix has a through hole, and the through hole exposing the substrate positioned under the black matrix, one end of the interval holding portion is extending to the through hole for contacting the exposed substrate.

8. A method of manufacture the liquid crystal panel, comprising steps:
providing a color filter substrate, the method of manufacture the color filter substrate comprising steps:
forming a black matrix on a substrate;
forming an interval holding portion, an end of the interval holding portion is contacted to the black matrix, and the interval holding portion is made by an organic material has low elasticity modulus and high extension rate;
providing an array substrate; and
assembling the array substrate corresponding to the color filter substrate such that another end of the interval holding portion is contacted to the array substrate for keeping distance between the array substrate and the color filter substrate.

9. The method of manufacture the liquid crystal panel according to claim 8, wherein the method of manufacture the color filter substrate further comprising steps:
forming a through hole in the black matrix after forming black matrix on the substrate and before forming the interval holding portion, and the through hole exposing the substrate positioned under the black matrix;
when forming the interval holding portion, one end of the interval holding portion is extending to the through hole for contacting the exposed substrate.

10. The method of manufacture the liquid crystal panel according to claim 8, wherein the method of manufacture the color filter substrate further comprising steps;
when forming the black matrix on the substrate, the black matrix defining openings by array distribution;
forming a red photoresist layer, a green photoresist layer or a blue photoresist layer in the correspondingly opening.

11. The method of manufacture the liquid crystal panel according to claim 9, wherein the method of manufacture the color filter substrate further comprising steps;
when forming the black matrix on the substrate, the black matrix defining openings by array distribution;
forming a red photoresist layer, a green photoresist layer or a blue photoresist layer in the correspondingly opening.

12. The method of manufacture the liquid crystal panel according to claim 8, wherein the organic material is made of at least one of epoxy, acrylate resin and polytetrafluoroethylene.
